(19) United States
(12) Patent Application Publication
(10) Pub. No.: US 2017/0195414 A1
(43) Pub. Date: Jul. 6, 2017

(54) Compact, Componentized Hardware Architecture and Reference Platform Family for Low-Power, Low-Cost, High-Fidelity In Situ Sensing

(71) Applicant: Clemson University, Clemson, SC (US)

(72) Inventor: Jason O. Hallstrom, Clemson, SC (US)

(73) Assignee: Clemson University

(21) Appl. No.: 14/619,825

(22) Filed: Feb. 11, 2015

Related U.S. Application Data
(63) Continuation-in-part of application No. 12/904,747, filed on Oct. 14, 2010, now abandoned.

(51) Int. Cl. H04L 29/08; H04L 12/813; H04L 12/721; H04L 12/24

(52) U.S. Cl. CPC H04L 67/1061; H04L 67/12; H04L 41/0893; H04L 47/20; H04L 45/70; H04L 67/1042; H04Q 2209/25; H04Q 2209/50; H04Q 2209/845

(57) ABSTRACT

A stackable mote device comprising at least one local sensor set comprising one or more configurable sensing devices is described. The configurable sensing devices are configured through power-gated sensor headers and configured to be electrically coupled by stacking in any order to transmit data to at least one communication. The said devices comprises in a stack of layers: a controlling circuit board comprising a microcontroller unit; at least one peripheral circuit board comprising a sensor; an interface circuit board comprising an interface; a storage circuit board configured to store information; and a communication circuit board comprising a radio transmitter. A power source is provided wherein the power source provides power to the local sensor set. A voltage disconnect is provided which is capable of disconnecting the power source from the local sensor set when the power source has a voltage below a threshold.

### CROSS REFERENCE TO RELATED APPLICATION

This application is a continuation-in-part application of pending U.S. patent application Ser. No. 12/904,747 filed Oct. 14, 2010 which, in turn, claims the benefit of and priority to expired U.S. Provisional Patent Application Ser. No. 61/251463 filed Oct. 14, 2009, both of which are fully incorporated herein by reference and made a part hereof.

### GOVERNMENT SUPPORT CLAUSE

This invention was made with government support under CNS-0745846 and CNS-1126344 both awarded by The US National Science Foundation, 4201 Wilson Boulevard, Arlington, Va. 22230. The government has certain rights in the invention.

### BACKGROUND

A sensor node, also known as a “mote,” is a node in a wireless sensor network, or wireless sensor set, that is capable of performing some processing, gathering sensory information, storage and communicating with other connected nodes in the network. The typical architecture of a mote generally comprises a micro-controller unit (MCU), an analog-to-digital converter (ADC), one or more sensors, a memory, a transceiver, and a power source.

Generally, though, prior-art motes are inflexible in their configuration, lack a number of features including the ability to accommodate multiple communications paths and digital sensor interfaces (in particular, SDI-12), and lack adequate power control for a wide range of peripherals (e.g., sensors). Further, these issues lead to faster power source depletion and more expensive data collection.

Therefore, what are needed are motes that overcome challenges in the art, some of which are described above, and methods of using them.

### SUMMARY

Described herein are embodiments of a hardware architecture and reference platform family for constructing low cost, long-lived, wireless data acquisition networks. Embodiments of the device are designed to enable data collection, data processing, data storage, and data communication across a broad range of sensor, storage, and communication technologies. When deployed at scale, the devices form an intelligent sensing fabric that can cover a large geographic area with minimal power requirements at a low cost. While the architecture was originally conceived to suit the requirements of the Intelligent River® program, the architecture and its platform realizations provide value to a range of industry segments, from agriculture and utilities to defense and manufacturing. For example, embodiments of the described invention can be used in applications such as resource management, smart transportation, precision agriculture, habitat monitoring, wildfire tracking, threat detection, smart structures, smart energy, smart-grids, etc.

Generally, device architecture of the embodiments is based on a stackable design. A wide electrical interconnect routes all power and processor signals vertically from the base of the stack through the supporting board layers. Site-specific device customizations are achieved by composing board layers that provide the desired services (e.g., MicroSD storage, cellular service, SDI-12 connectivity). Fine-grained power management is an over-arching goal for each layer of the architecture. Embodiments of the disclosed invention can provide from over five months to over one year of operation on a single 9v battery.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

An embodiment of the invention is provided in a stackable mote device comprising at least one local sensor set comprising one or more configurable sensing devices. The configurable sensing devices are configured through power-gated sensor headers and configured to be electrically coupled by stacking in any order to transmit data to at least one communication. The said devices comprises in a stack of layers: a controlling circuit board comprising a microcontroller unit; at least one peripheral circuit board comprising a sensor; an interface circuit board comprising an interface; a storage circuit board configured to store information; and a communication circuit board comprising a radio transmitter. A power source is provided wherein the power source provides power to the local sensor set. A voltage disconnect is provided which is capable of disconnecting the power source from the local sensor set when the power source has a voltage below a threshold.

Yet another embodiment is provided in a remote sensing device. The remote sensing device comprises a plurality of peripheral circuit boards, wherein each peripheral circuit board comprises a sensor. A communication circuit board is provided comprising an antenna and a transmitter. A storage circuit board configured to store information is integral to the remote sensing device as is an interface circuit board comprising an interface. A controlling circuit board, comprising a processor, is configured to be electrically coupled by an electrical interconnect configured to transfer data signals and power signals through power-gated sensor headers to the communication circuit board, the storage circuit board, the interface circuit board, and the plurality of peripheral circuit boards by stacking the communication circuit board, the storage circuit board, the interface circuit board, and the plurality of peripheral circuit boards upon the controlling circuit board by a wide electrical interconnect in any order. A power source is electrically configured to provide power through the electrical interconnect to the controlling circuit board, the storage circuit board, the communication circuit board, the interface circuit board and the plurality of peripheral circuit boards.

Yet another embodiment is provided in a configurable remote sensing device. The remote sensing device comprises an enclosure containing powered components comprising a controlling circuit board comprising at least one microcontroller unit; at least one peripheral circuit board comprising a sensor; a storage circuit board configured to store information; and a communication circuit board comprising a radio transmitter; a power source; and a voltage disconnect capable of disconnecting said power source from said powered components upon a voltage dropping below a preset threshold. The powered components are electrically coupled by physically polarized power-gated headers configured to transfer data signals and power signals through the peripheral circuit board, the storage circuit board, and the communication circuit board and the powered components are configured to be electrically coupled by stacking the controlling circuit board, the peripheral circuit board(s), the interface circuit board, the storage circuit board, and the communication circuit board in any order.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is a block diagram illustrating typical architecture of a mote;

FIGS. 2A-2D illustrate one embodiment of a stackable mote comprising a processor board (FIG. 2A), an interface board (FIG. 2B), and a radio board (FIG. 2C), and FIG. 2D shows an assembled reference platform composed by stacking the three layers;

FIG. 3A illustrates a layout diagram of an embodiment of an exemplary processor board that can be used in an embodiment of a stackable mote;

FIGS. 3B and 3D-3G illustrates an electrical schematic for the embodiment of processor board shown in FIG. 3A;

FIG. 3C is an exemplary bill of materials for the embodiment of a processor board shown in FIGS. 3A, 3B and 3D-3G;

FIG. 4A illustrates a layout diagram of an embodiment of an exemplary interface board that can be used in an embodiment of a stackable mote;

FIGS. 4B and 4D-4H illustrates an electrical schematic for the embodiment of an interface board shown in FIG. 4A;

FIG. 4C is an exemplary bill of materials for the embodiment of an interface board shown in FIGS. 4A, 4B and 4D-4H;

FIG. 5A illustrates a layout diagram of an embodiment of an exemplary radio board that can be used in an embodiment of a stackable mote;

FIGS. 5B and 5D illustrates an electrical schematic for the embodiment of a radio board shown in FIG. 5A;

FIG. 5C is an exemplary bill of materials for the embodiment of a radio board shown in FIGS. 5A, 5B and 5D;

FIG. 6A illustrates a layout diagram of an embodiment of an exemplary storage board that can be used in an embodiment of a stackable mote;

FIGS. 6B and 6D illustrates an electrical schematic for the embodiment of a storage board shown in FIG. 6A;

FIG. 6C is an exemplary bill of materials for the embodiment of a storage board shown in FIGS. 6A, 6B and 6D;

FIG. 7 is a pin-out chart for an embodiment of a processor that illustrates the interconnectivity between the various boards that comprise an embodiment of a stackable mote;

FIG. 8 is a block diagram illustrating an exemplary operating environment for performing the disclosed methods;

FIGS. 9A-9E illustrate one embodiment of a stackable mote comprising a processor board (FIG. 9A), a storage board (FIG. 9B), a radio board (FIG. 9C) and an interface board (FIG. 9D);

FIG. 9E shows an assembled reference platform composed by stacking the four layers;

FIGS. 10A and 10B are an electrical schematic of an undervoltage disconnect.

### DETAILED DESCRIPTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

The methods and systems may include a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Described herein are embodiments of sensor nodes, or motes, that can be used in an in situ monitoring network and system such as, for example the Intelligent River® project, an end-to-end hardware/software infrastructure engineered to support real-time monitoring and management of water resources focused initially across the state of South Carolina. In the Intelligent River® project, the sensing fabric comprises a range of heterogeneous devices. While the system could be simplified by adopting a single sensing platform, doing so would limit the set of environmental and hydrological parameters that could be captured and would couple the system to a particular technology provider. Hence, a range of sensing platforms is deployed. Described herein are embodiments of a compact, componentized hardware architecture and reference platform family for low-power, low-cost, high-fidelity in situ sensing.

Design features for the described embodiments include: (i) support for multiple analog sensors, (ii) high-fidelity data sampling, (iii) inexpensive production, and (iv) design simplicity. Supplementary objectives addressed in the design embodiments described herein include (i) increased hardware configurability and programmability, (ii) improved power management, (iii) support for common digital sensor interfaces, and (iv) the addition of basic user interface elements.

The described embodiment boards can be stacked to enable application-specific customization. In the described embodiment, the monolithic structure common to commercial platforms is replaced in favor of a componentized architecture. By composing layers that provide basic services, site engineers can assemble a platform tailored to their specific deployment needs.

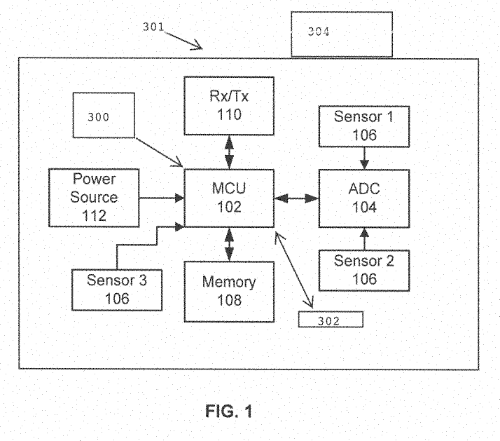

An exemplary block diagram of a mote is illustrated in FIG. 1. In FIG. 1, the mote is illustrated as being within an encasement 301, which is preferred. A microcontroller unit (MCU) 102, can be connected to several components. Each component can be placed on one or more circuit boards. The components of the mote can comprise but are not limited to at least one sensor 106, at least one analog-to-digital converter 104, a memory 108, a power source 112, and a radio transmitter. In another aspect the components can comprise a radio transceiver 110. At least one integrated USB, and preferably a micro-USB or micro-mini USB, is preferably provided at at least one component. Preferably the USB is coupled to the MCU to allow for pre-programming and in-field diagnostics and may be in integral part of the MCU. Alternatively, a USB can be provided on, or be integral to, at least one other component, such as a sensor, the radio transceiver or the memory module, in lieu of or in addition to the USB integral to the MCU, and then electrically coupled to the USB. If the USB is integral to a component other than the MCU it is preferable that the USB provide a communication link with the MCU. The USB provides for enhanced support of the MCU and other modules. At least one component preferably comprises a global positioning satellite sensor (GPS). The GPS can be integral to the radio transceiver and may be a cellular GPS integral to a cellular radio transceiver. Alternatively, a sensor may be a dedicated integral GPS which provides improved spatial resolution relative to cellular based GPS systems. A clock 302, and preferably a real-time clock is preferably included in the mote for correlation of acquired data with time or for diagnostics of system aberrations or deviations from normal activity.

Integrity of the enclosure 301, is of utmost importance in some environments, particularly harsh environments. An integrity sensor 300, provides analysis pertinent to the integrity of the enclosure. The parameter measured is defined based on either the environment of use or the risk caused by the particular environmental condition. It is preferable that the integrity sensor be in communication with the MCU thereby allowing for either corrective action or protective action upon sensing of a breach, or potential breach, of the security of the encasement. Temperature, for example, may be monitored and if a threshold temperature is reached, a data download, through the radio transceiver for example, may be automatically executed thereby preserving the acquired data. Alternatively, any acquired data may be automatically stored on the memory module upon a threshold being reached in a monitored parameter. Monitored parameters are preferably selected from temperature, moisture, motion, pressure, elemental or chemical analysis and other parameters which may be appropriate for a given condition.

A display 304, which is either internal to the encasement, integral to the encasement, external to the encasement or visible through the encasement is provided for visible confirmation or review of parameters displayed thereon. A particularly preferred display is a colosteric liquid crystal display due to their ability to retain the image without power. Colosteric liquid crystal displays are available commercially from Kent Displays, Inc. Colosteric liquid crystal displays are particularly energy efficient due to the low energy required to convert the image from one stable image, or lack thereof, to another stable image, or lack thereof, wherein the image remains without further power consumption. The display can be used in conjunction with either the integrity sensor or an undervoltage disconnect wherein a report can be recorded on the display and the report will remain after power disconnect or failure thereby allowing for analysis of the system.

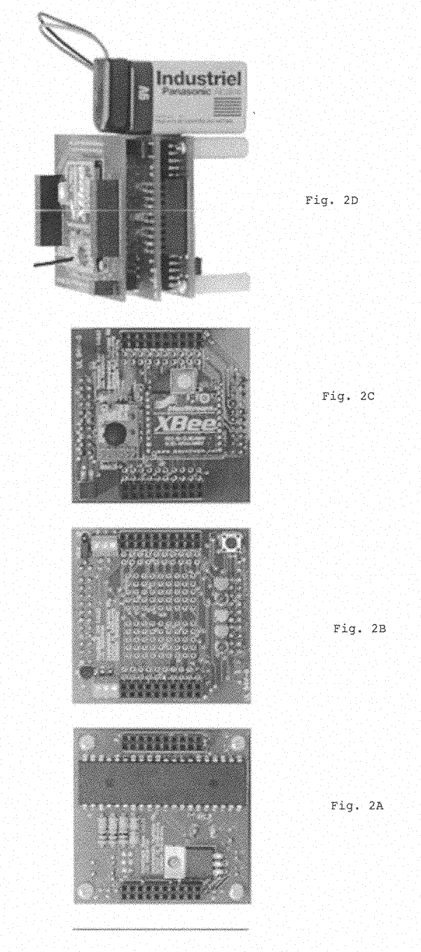

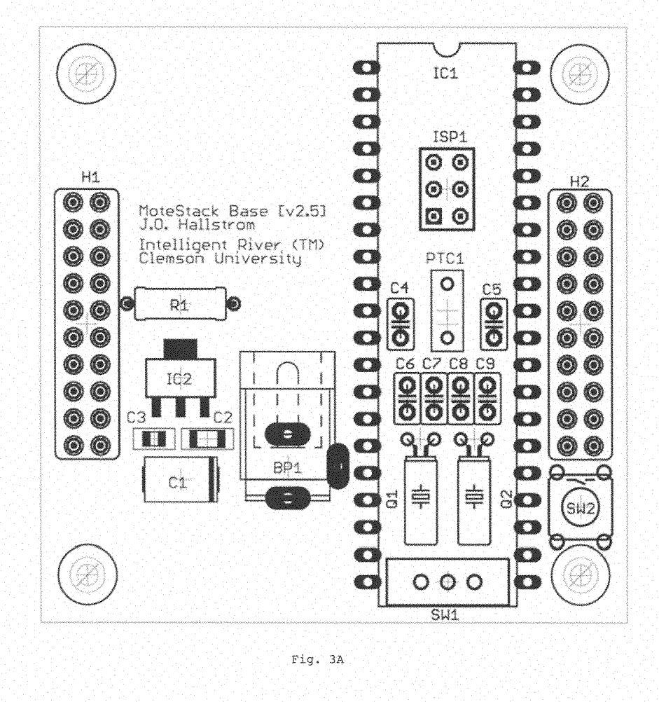

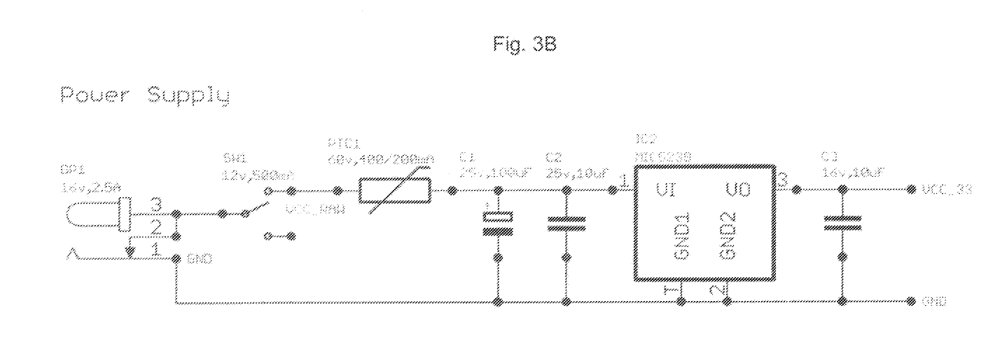

One embodiment of a stackable mote is shown in FIGS. 2A-2D comprising a processor board, an interface board, and a radio board. FIG. 2A shows the processor board. In addition to providing basic power regulation and noise filtering, the board hosts a general purpose microcontroller (MCU). For example, in the design shown in FIG. 2A, an AVR microcontroller with an integrated 10-bit ADC unit is used, though other MCUs may also be used. The standard 6-pin ISP header is exposed for device programming. FIG. 2B shows an interface board. In addition to providing basic user interface elements (e.g., LEDs, tactile switches, headers, etc.), the board can expose standard digital interfaces (e.g., I²C, SPI, 1-Wire, etc.) for attaching external components and sensors. Power gating circuitry can also be included to provide improved energy conservation during idle periods. FIG. 2C shows an embodiment of a radio board. Various wireless communications technologies may be used in different radio board embodiments including, for example, 3G/4G cellular, Wi-Fi (IEEE 802.11n), ZigBee, Bluetooth, WiMAX, etc. The employed communication technology can be selected and configured for a stackable mote based on coverage, foliage penetration, data rate, and topology characteristics due to their operating frequency, power constraints, and radio techniques. For a given technology, the radio configuration (e.g., transmission power, amplifiers, antenna, etc.) can be adjusted to a limited extent according to the network coverage, transport capacity, and packet reception requirements.

FIG. 2D shows an assembled reference platform composed by stacking the three layers (processor board, interface board, and radio board). Additional boards may be added as appropriate, for instance, to provide support for high capacity nonvolatile storage, an SDI-12 board for aquatic sensor connectors, a solar board to provide a power source, and a cellular radio board.

Stackable mote devices deployed in the field can be programmed to mirror the functionality of single board motes. However, the stackable configuration allows for an improved power consumption profile. Depending on the radio and sensor configuration, the device can operate for several months or more on a 9v battery.

Board Details:

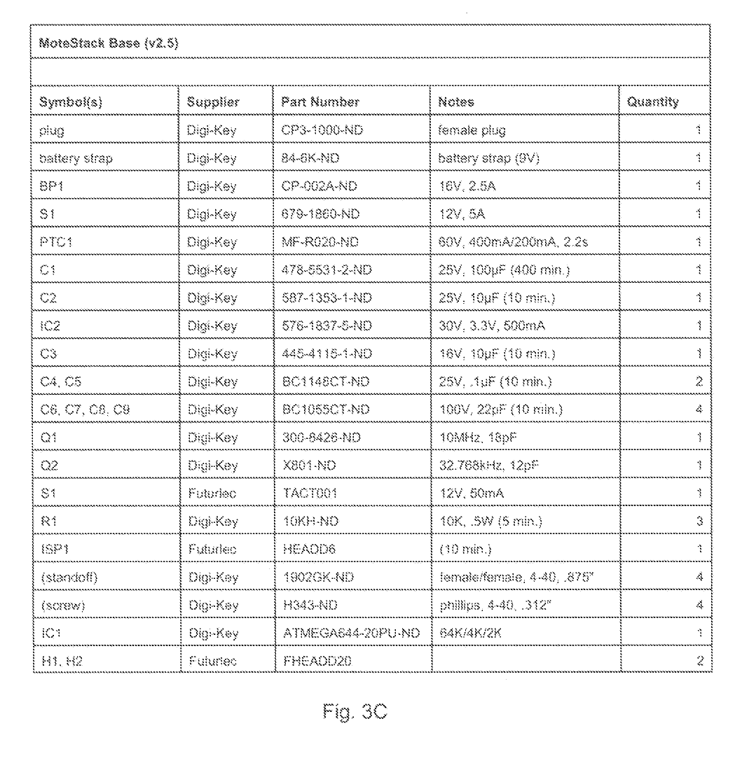

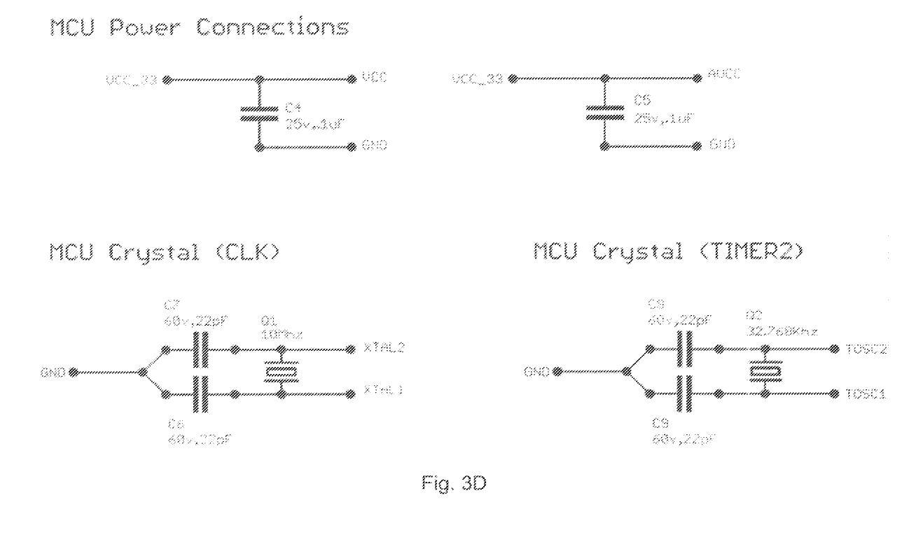

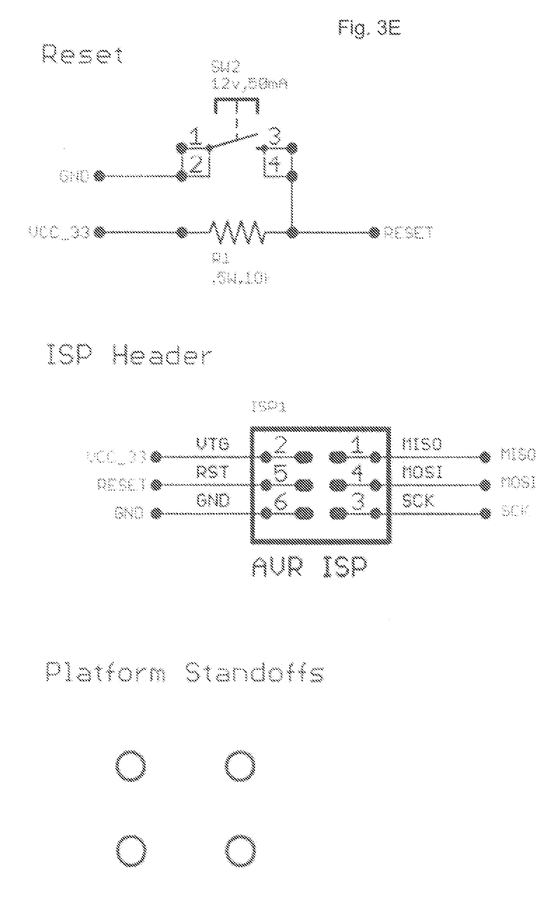

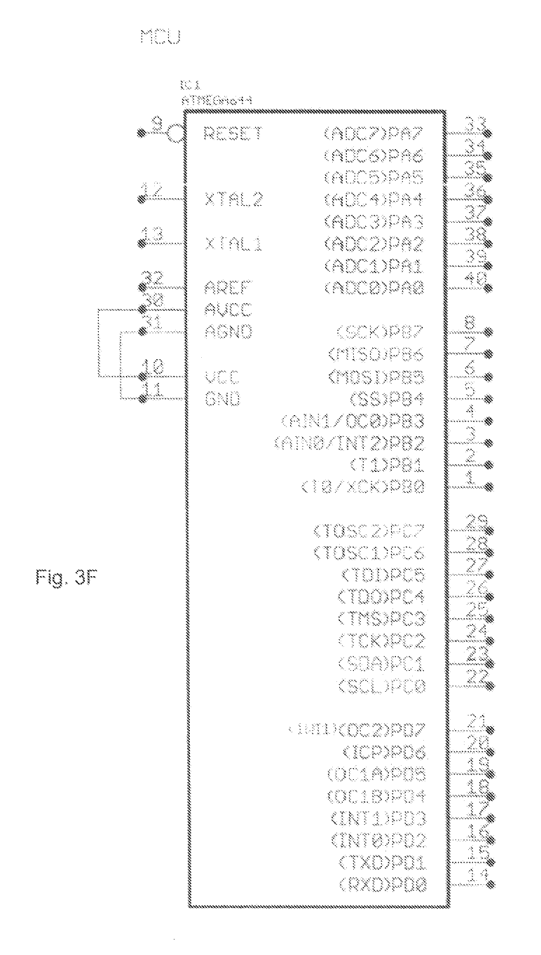

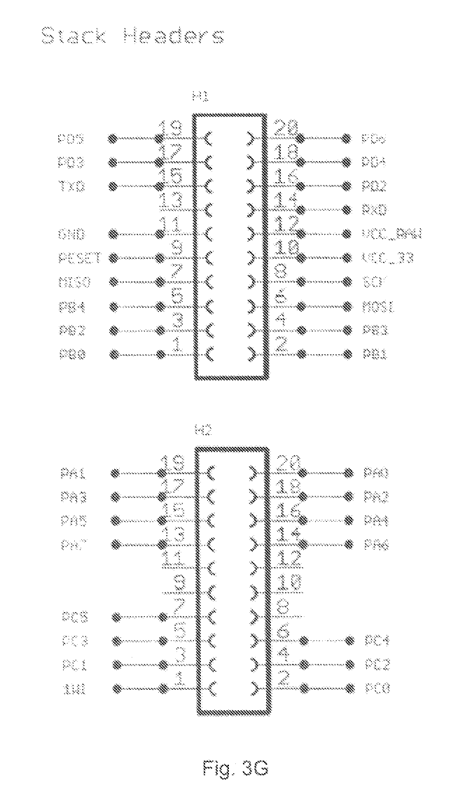

FIG. 3A illustrates a layout diagram of an embodiment of an exemplary processor board that can be used in an embodiment of a stackable mote. FIGS. 3B and 3D-3G illustrates an electrical schematic for the embodiment of processor board shown in FIG. 3A. FIG. 3C is an exemplary bill of materials for the embodiment of a processor board shown in FIGS. 3A, 3B and 3D-3G. In one embodiment, the processor board comprises a 3.3V/5V regulated power supply (with protection), 64K ROM, 4K RAM (expandable), 2K flash memory (expandable), eight-10 bit ADC ports (expandable) and SPI, I²C, and I-Wire ports.

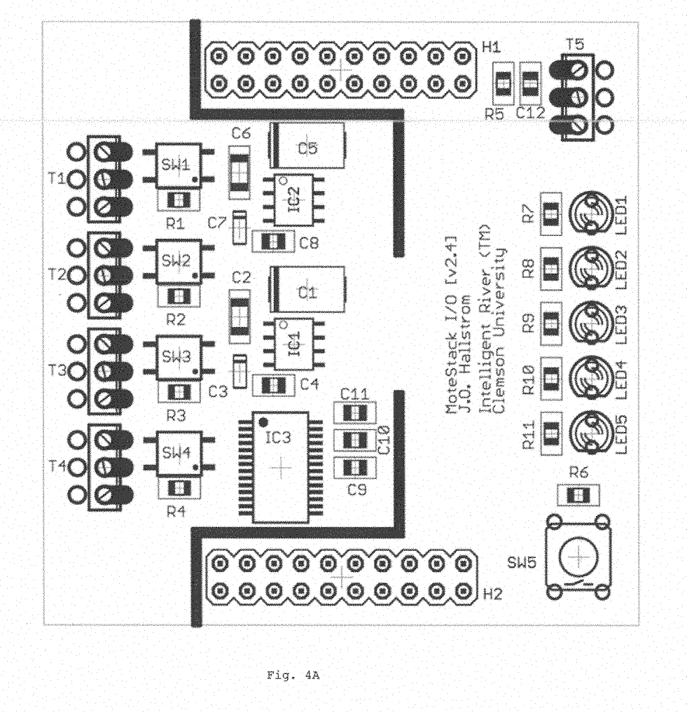

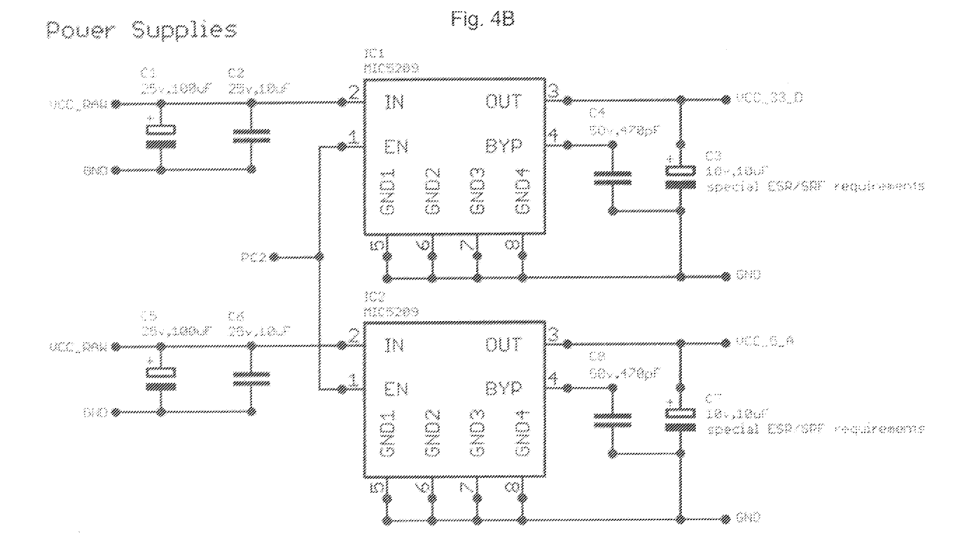

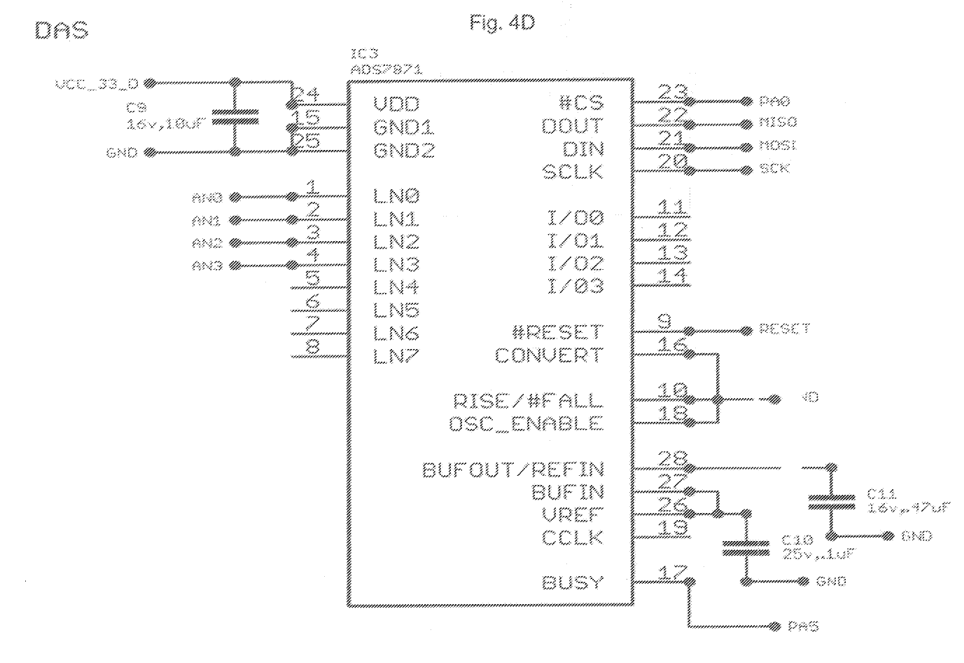

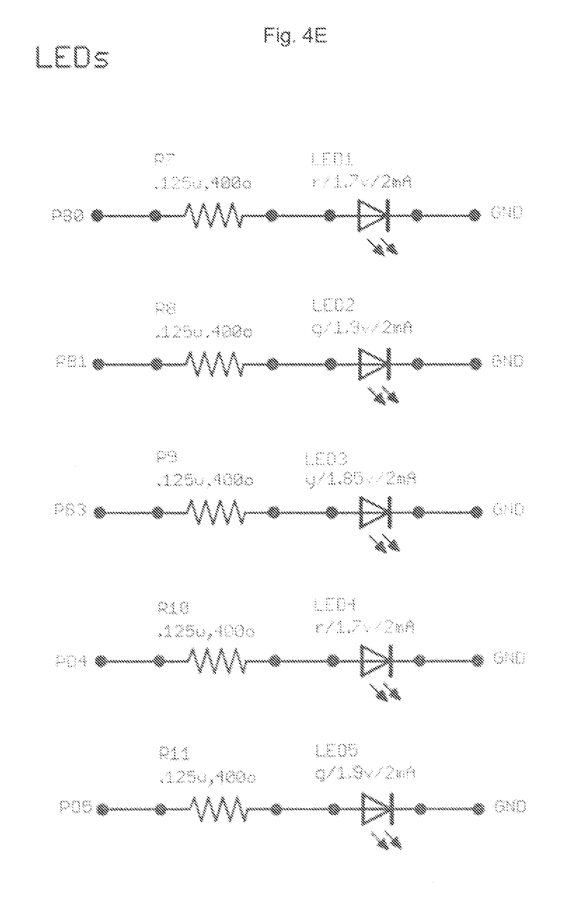

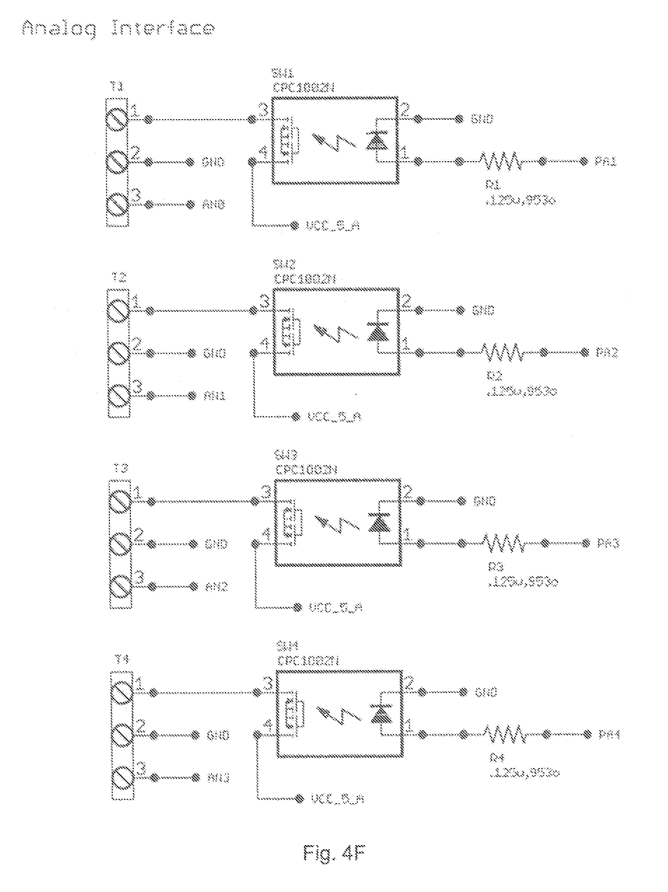

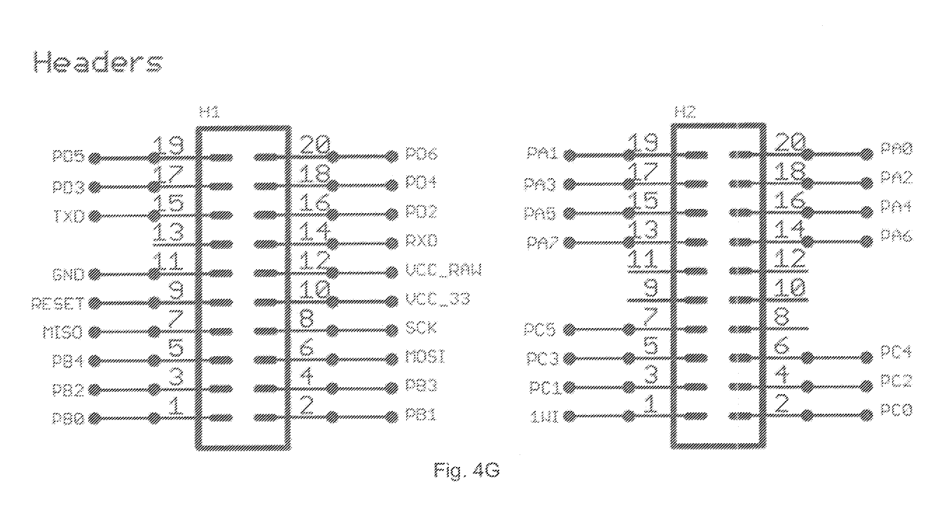

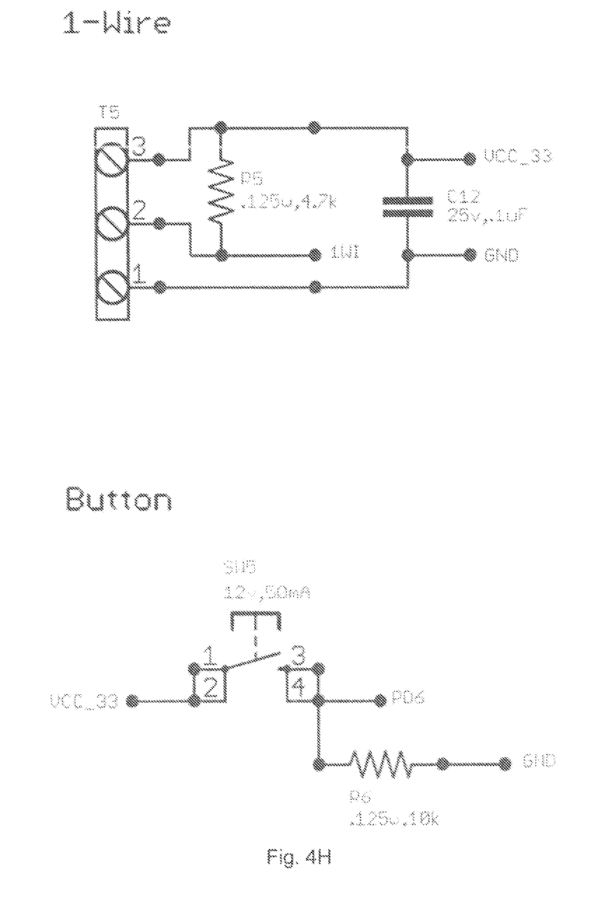

FIG. 4A illustrates a layout diagram of an embodiment of an exemplary interface board that can be used in an embodiment of a stackable mote. FIGS. 4B and 4D-4H illustrates an electrical schematic for the embodiment of an interface board shown in FIG. 4A. FIG. 4C is an exemplary bill of materials for the embodiment of an interface board shown in FIGS. 4A, 4B and 4D-4H. In one embodiment, the interface board comprises LEDs, one or more tactile switches, power-gated sensor headers, 14-bit ADC, programmable gate amplifier (PGA), opto-isolated power gates, separate analog/digital regulators/ground planes and a one-wire header. The power-gated sensors are preferably physically polarized power-gated sensor headers.

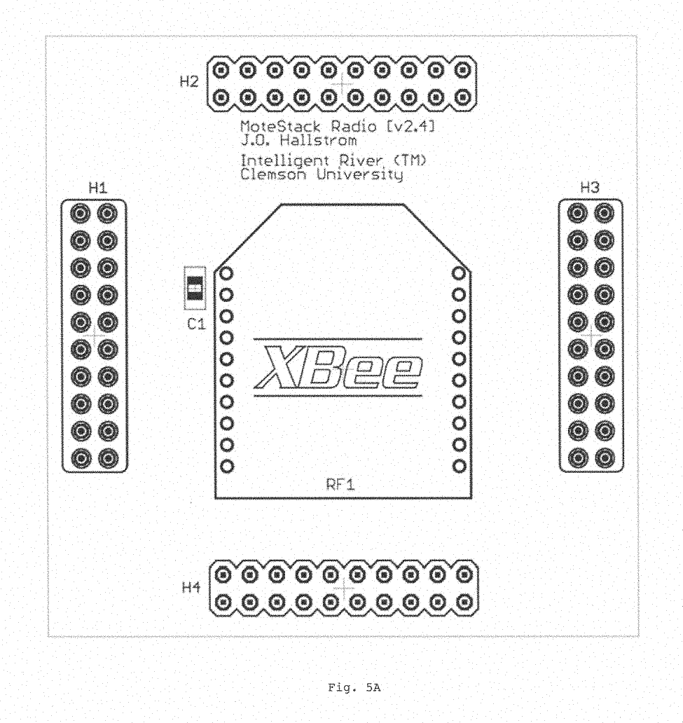

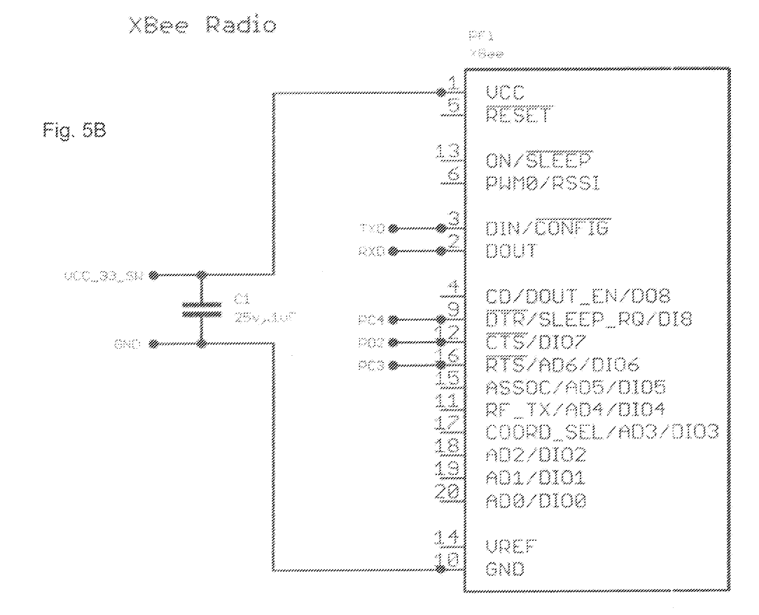

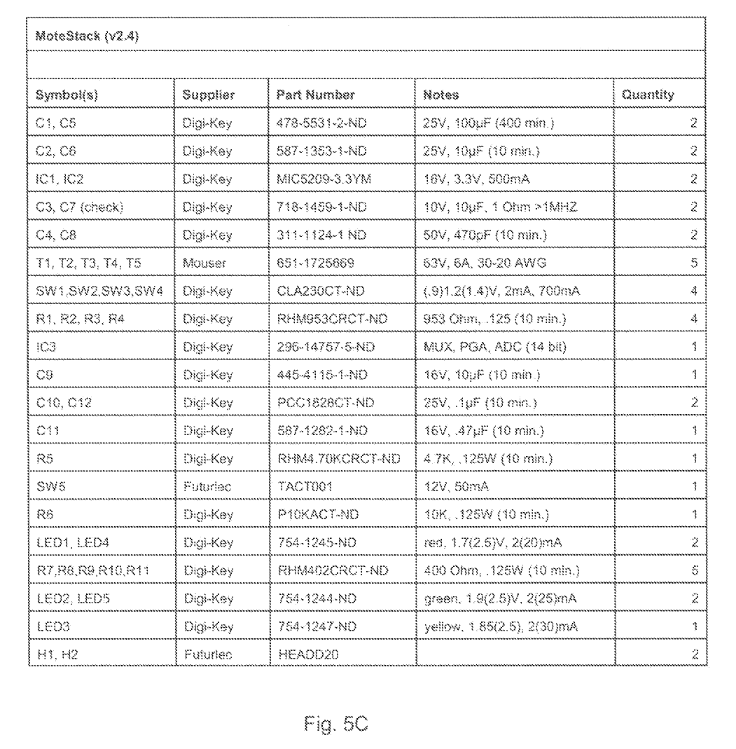

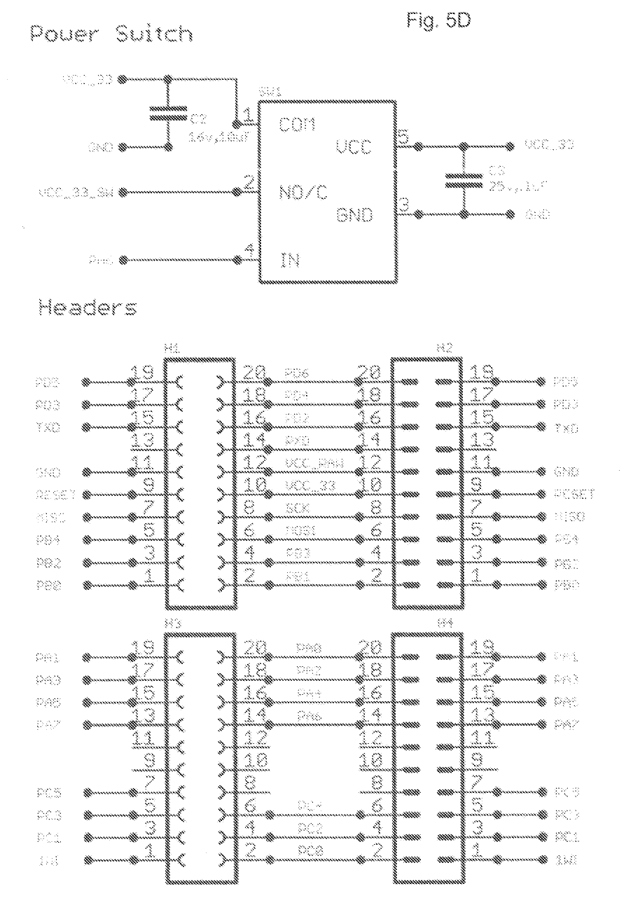

FIG. 5A illustrates a layout diagram of an embodiment of an exemplary radio board that can be used in an embodiment of a stackable mote. FIGS. 5B and 5D illustrates an electrical schematic for the embodiment of a radio board shown in FIG. 5A. FIG. 5C is an exemplary bill of materials for the embodiment of a radio board shown in FIGS. 5A, 5B and 5D. In one embodiment, the radio board comprises an IEEE 802.15.4 ZigBee transceiver and optionally a 433 MHz (out of band) transceiver.

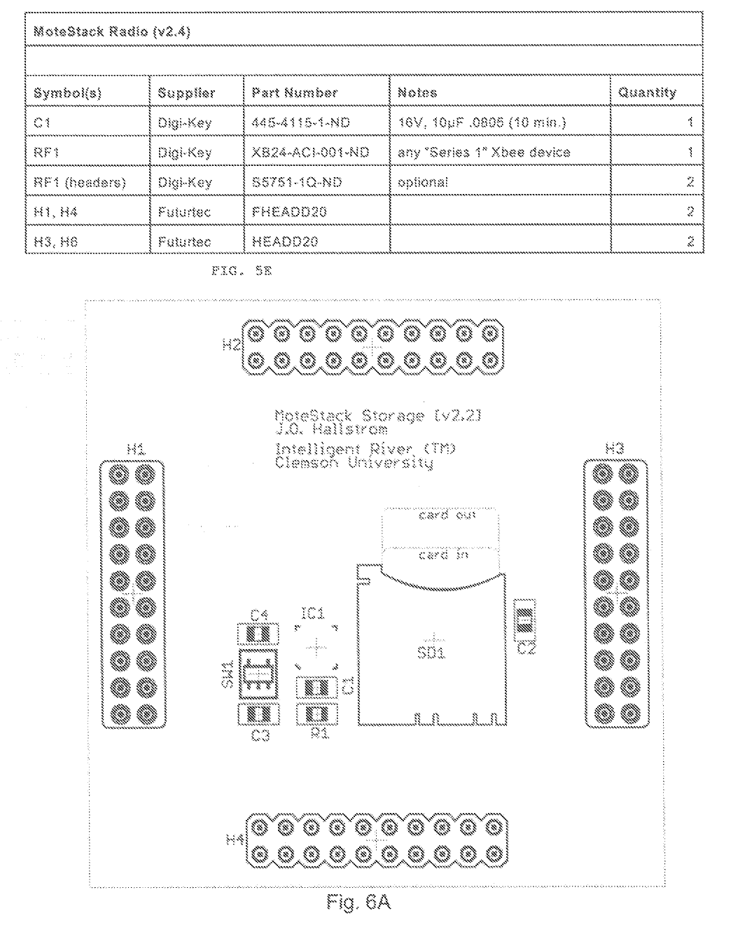

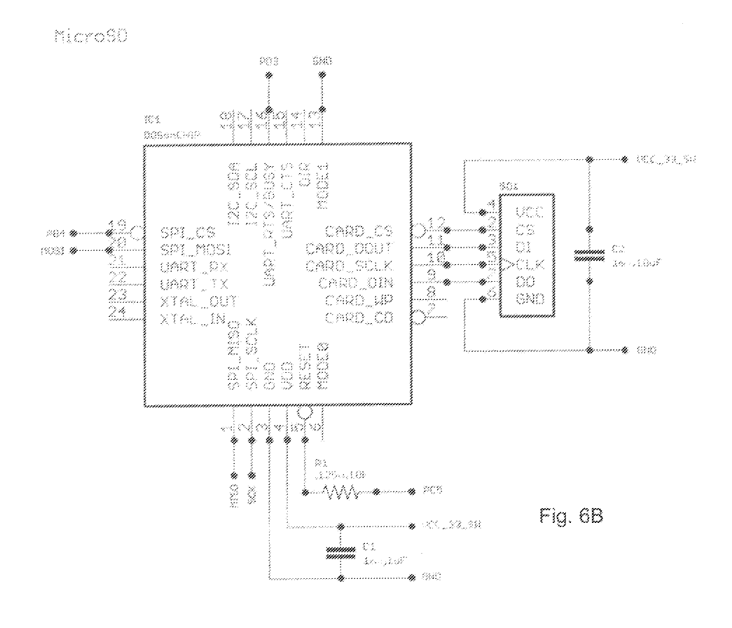

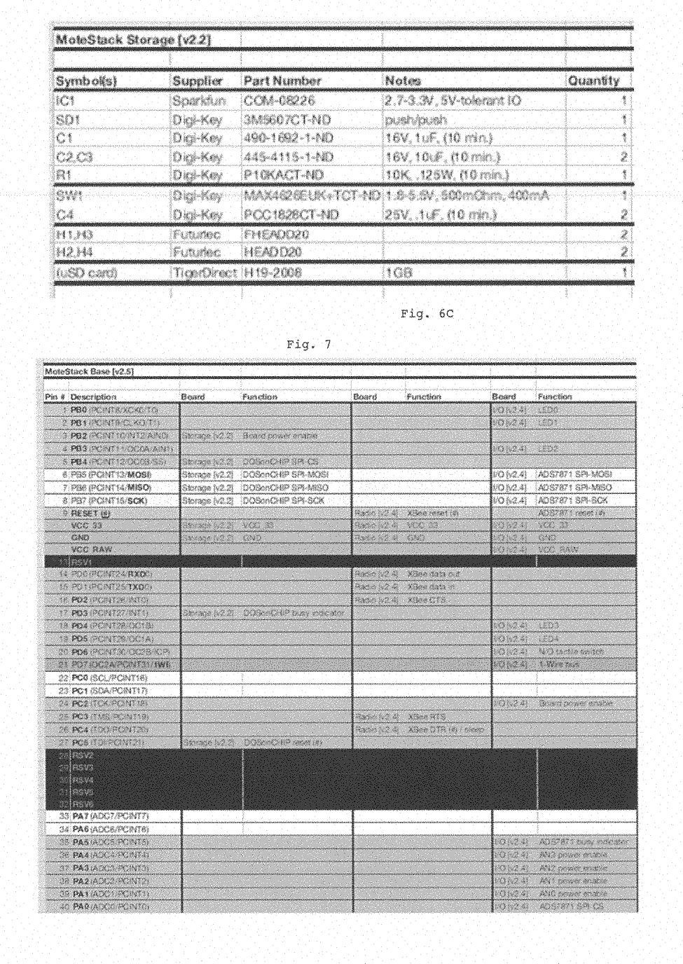

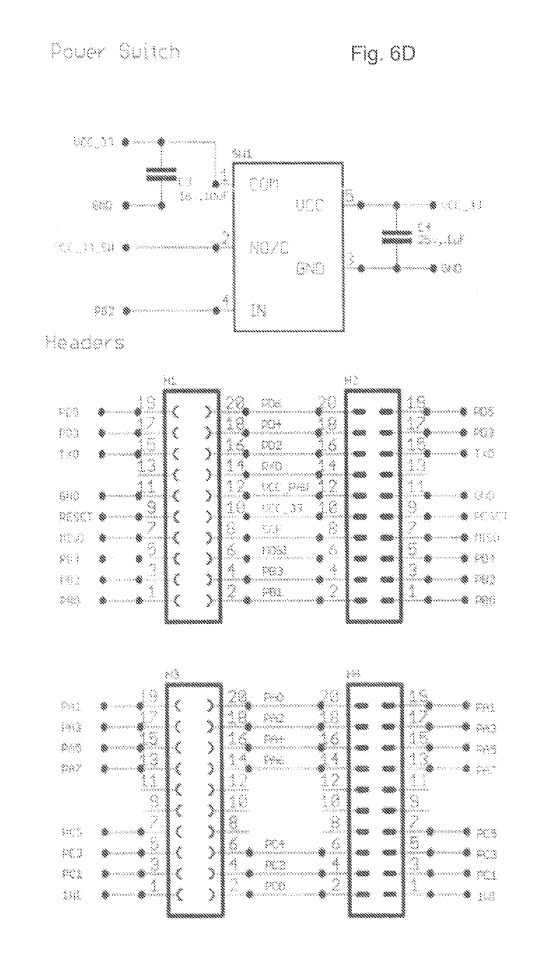

FIG. 6A illustrates a layout diagram of an embodiment of an exemplary storage board that can be used in an embodiment of a stackable mote. The storage board can be used to provide memory to a stackable mote such as, for example, high-capacity nonvolatile storage such as a 2 GB MicroSD. FIGS. 6B and 6D illustrates an electrical schematic for the embodiment of a storage board shown in FIG. 6A. FIG. 6C is an exemplary bill of materials for the embodiment of a storage board shown in FIGS. 6A, 6B and 6D. The headers in FIGS. 6B and 6D are preferable polarized headers with a physical orientation which prohibits connectivity if not aligned properly. The physical polarization can be accomplished by the use of pin geometry, pin size or by the combination of physical components, such as protrusions and indentions, which prohibit adjacent headers from connectivity if not properly oriented. The headers allow vertical transfer of data signals and power signals thereby significantly enhancing miniaturization.

FIG. 7 is a pin-out chart for an embodiment of a processor (see FIGS. 3B and 3D-3G) that illustrates the interconnectivity between the various boards that comprise an embodiment of a stackable mote. In this example, the stackable mote is comprised of an interface (I/O) board, a radio board, a processor board, and a storage board.

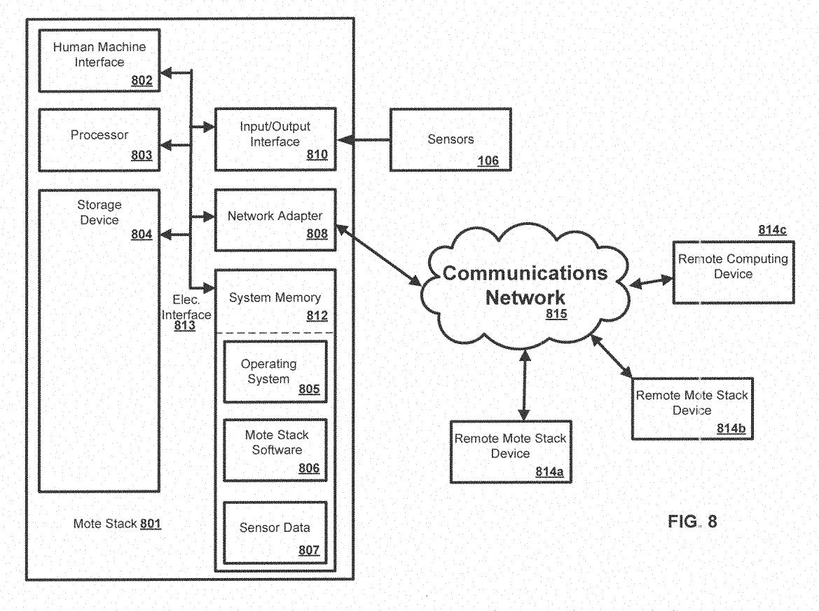

The system has been described above as comprised of units which are functionally linked by a combination of hardware and software. The units can comprise the mote stack software 806 as illustrated in FIG. 8 and described below. In one exemplary aspect, the units can comprise a mote stack 801 as illustrated in FIG. 8 and described below.

FIG. 8 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be in functional communication with general purpose or special purpose computing system environments or configurations for monitoring the performance of the mote stack, retrieving information collected by or stored on the mote stack or for reconfiguring the mote stack. Examples of well known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a mote stack 801. The components of the mote stack 801 can comprise, but are not limited to, one or more processors or processing units 803, a system memory 812, and an electrical interface 813 that couples various system components including the processor 803 to the system memory 812. In the case of multiple processing units 803, the system can utilize parallel computing.

The electrical interface 813 interconnects each of the subsystems of the mote stack 801, including the processor 803 and a storage device 804. An operating system 805, mote stack software 806, sensor data 807 may be resident on a module referred to as system memory 812. A network adapter (e.g., radio) 808, an Input/Output Interface 810, and an optional human machine interface 802, each of which can be contained within one or more remote mote stack devices 814a,b at physically separate locations, connected through a communications network 115, in effect implementing a fully distributed system. The distributed system can also communicate via the communications network 115 with one or more remote computing devices 814c, such as a computer or server, for example.

The mote stack 801 typically comprises a variety of computer readable media. Exemplary readable media can be any available media that is accessible by the mote stack 801 and can comprise, for example and not meant to be limiting, both volatile and non-volatile media, removable and non-removable media. The system memory 812 can comprise computer readable media in the form of volatile memory, such as random access memory (RAM), and/or non-volatile memory, such as read only memory (ROM). The system memory 812 typically contains data such as sensor data 807 and/or program modules such as operating system 805 and mote stack software 806 that are immediately accessible to and/or are presently operated on by the processing unit 803.

In another aspect, the mote stack 801 can also comprise other removable/non-removable, volatile/non-volatile computer storage media. By way of example, FIG. 8 illustrates a mass storage device 804 which can provide non-volatile storage of computer code, computer readable instructions, data structures, program modules, and other data for the mote stack 801. For example and not meant to be limiting, the mass storage device 804 is preferably a flash memory cards such as MicroSD or other storage technologies can be implemented such as a hard disk, a removable magnetic disk, a removable optical disk, magnetic cassettes or other magnetic storage devices, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 804, including by way of example, an operating system 805 and mote stack software 806. Each of the operating system 805 and mote stack software 806 (or some combination thereof) can comprise elements of the programming and the mote stack software 806. Sensor data 807 can also be stored on the mass storage device 804.

In another aspect, the user can enter commands and information into the mote stack 801 via an input device (not shown). Examples of such input devices comprise, but are not limited to, a computer, a keyboard, pointing device (e.g., a “mouse”), a microphone, a joystick, tactile input devices such as gloves, and other body coverings, and the like. These and other input devices can be connected to the processing unit 803 via a human machine interface 802 that is coupled to the electrical interface 813.

Other peripheral devices can comprise components such as, for example, one or more sensors 106, which can be connected either directly to the mote stack 801 via an Input/Output Interface 810, or through an ADC (not shown).

The mote stack 801 can operate in a networked environment using logical connections to one or more remote mote stacks 814a,b, or one or more remote computing devices 814c. By way of example, a remote computing device 814c can be a personal computer, portable computer, a server, a router, a network computer, a peer device or other common network node, and so on. Logical connections between the mote stack 801 and a remote mote stacks 814a,b or remote computing device 814c can be made via a communications network 815 such as, for example, a cellular communications network. Such network connections can be through a network adapter 808. A network adapter 808 can be implemented in both wired and wireless environments.

For purposes of illustration, application programs and other executable program components such as the operating system 805 are illustrated herein as discrete blocks, although it is recognized that such programs and components reside at various times in different storage components of the computing device 801, and are executed by the data processor(s). An implementation of mote stack software 806 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory (e.g., MicroSD) or other memory technology. CD-ROM, digital versatile disks (DVD) or other optical storage, magnetic cassettes, magnetic tape, magnetic disk storage or other magnetic storage devices, or any other medium which can be used to store the desired information and which can be accessed by a computer, however, these are less desirable.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

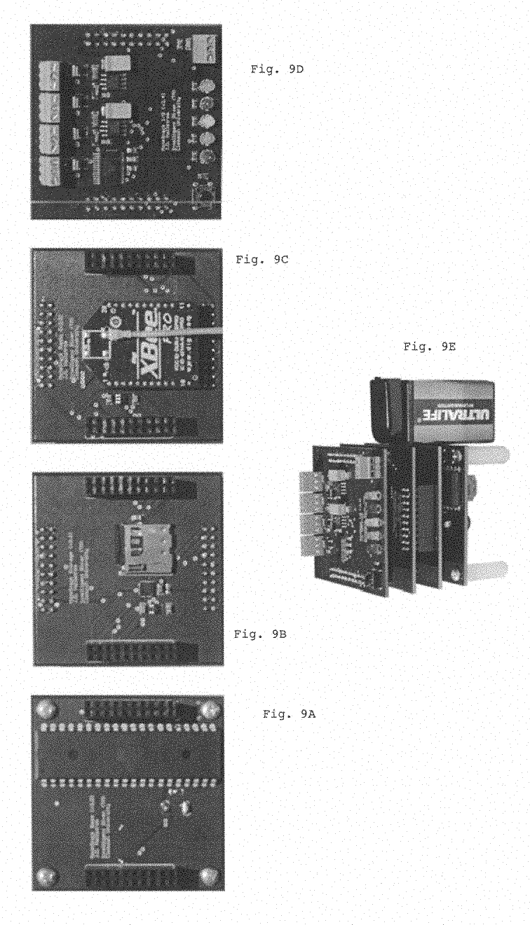

One embodiment of a stackable mote is shown in FIGS. 9A-9E comprising a processor board, a memory board, a radio board, and an interface board. FIG. 9A shows the processor board. In addition to providing basic power regulation and noise filtering, the board hosts a general purpose microcontroller (MCU). For example, in the design shown in FIG. 9A, an AVR microcontroller is used, though other MCUs may also be used. FIG. 9B shows a storage board which provides memory for data storage. For example, in the design shown in FIG. 9D, the board supports up to 32 GB of non-volatile storage on a removable, FAT-based microSD card, though other storage devices and formats may be used. FIG. 9C shows an embodiment of a radio board. Various wireless communications technologies may be used in different radio board embodiments including, for example, 3G/4G cellular, Wi-Fi (IEEE 802.11n), ZigBee, Bluetooth, WiMAX, etc. the employed communication technology can be selected and configured for a stackable mote based on coverage, foliage penetration, data rate, and topology characteristics due to their operating frequency, power constraints, and radio techniques. For a given technology, the radio configuration (e.g., transmission power, amplifiers, antenna, etc.) can be adjusted to a limited extent according to the network coverage, transport capacity, and packet reception requirements. FIG. 9D shows an interface board. In addition to providing basic user interface elements (e.g., LEDs, tactile switches, headers, etc.), the board can expose standard digital interfaces (e.g., I²C, SPI, 1-Wire, etc.) for attaching external components and sensors. Power management software and power gating circuitry can also be included to provide improved energy conservation during idle periods. For example, in the design shown in FIG. 9D, the board provides a 14-bit ADC with an integrated programmable gain amplifier and can support 4 opto-isolated sensors.

FIG. 9E shows an assembled reference platform composed by stacking the four layers (processor board, memory board, radio board, and interface board). Additional boards may be added as appropriate, for instance, to provide support for high capacity nonvolatile storage, an SDI-12 board for aquatic sensor connectors, a solar board to provide a power source, and a cellular radio board. As configured in FIG. 9E, the device can operate in the field for over one year on a 9v battery when sampling digital and analog sensors every fifteen minutes. It would be realized that the battery life is dependent on sensor power requirements. Component costs for this example, including the bare PCBs, are approximately $110.00 per unit when produced in 100-unit lots. The cost varies based on device configuration and drops substantially at larger volumes. Using a stackable implementation gives a user the ability to customize the device based on application-specific needs.

While the methods and systems have been described in connection with preferred embodiments and specific examples, it is not intended that the scope be limited to the particular embodiments set forth, as the embodiments herein are intended in all respects to be illustrative rather than restrictive.

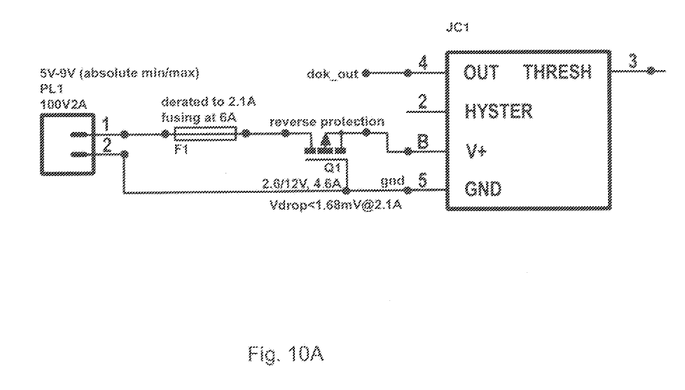

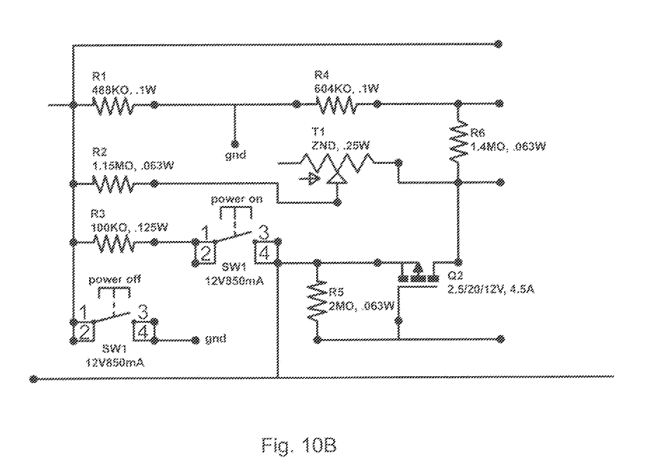

An undervoltage disconnect is illustrated in schematic view in FIG. 10. An undervoltage disconnect protects circuitry and data from loss of power. Typical disconnects function below a set voltage and partially disconnect a circuit below a certain voltage. Particularly, with gel cell batteries the voltage changes under load therefore when the threshold voltage is reached the load is removed which allows the battery to cycle back up. With conventional systems the voltage increase, that occurs when the load is removed, causes the load to be reapplied momentarily. The cycling of load ultimately causes complete, or near complete, discharge of the battery. With an undervoltage disconnect a lower limit of voltage is set and upon reaching that voltage the battery is electrically disconnected from the load and remains disconnected until overridden. It is preferable to have a first lower voltage limit and, if reached, an action is taken to secure data just prior to the disconnect which occurs upon reaching the second or threshold lower voltage limit. For example, if the first lower voltage limit is reached a shut-down report may be generated wherein the conditions of the shut-down are provided along with any pertinent data. Alternatively, the acquired data may be stored in the memory module or reported beyond the mote such as by a radio signal. The undervoltage disconnect preferably comprises a variable resistor for setting the threshold voltage at which point the circuit is disrupted. Particularly preferred undervoltage disconnects are self monitoring and configurable either by integral connectivity or connectivity through an MCU.

Power is typically DC power. A linear regulator can be employed but they are less desirable due to the lack of switching and heating issues. A switching regulator is preferred due to minimized heating and increased efficiency. For the purposes of the instant invention boards and circuits which require or receive power are referred to as powered components.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications may be referenced. Unless otherwise noted, the disclosures of these publications in their entireties are hereby incorporated by reference into this application in order to more fully describe the state of the art to which the methods and systems pertain.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following inventive concepts.

What is claimed is:

1. A stackable mote device comprising:
at least one local sensor set comprising one or more configurable sensing devices, configured through power-gated sensor headers and configured to be electrically coupled by stacking in any order to transmit data to at least one communication, said sensing devices comprising in a stack of layers:
a controlling circuit board comprising a microcontroller unit;
at least one peripheral circuit board comprising a sensor;
an interface circuit board comprising an interface;
a storage circuit board configured to store information; and
a communication circuit board comprising a radio transmitter;
a power source wherein said power source provides power to said local sensor set; and
a voltage disconnect capable of disconnecting said power source from said local sensor set when said power source has a voltage below a threshold.

2. The stackable mote device of claim 1 further comprising at least one of a GPS and a flash memory card reader.

3. The stackable mote device of claim 1, wherein said sensing devices are programmed to transmit or receive data asynchronously.

4. The stackable mote device of claim 1 further comprising an encasement.

5. The stackable mote device of claim 4 further comprising an integrity sensor associated with said encasement.

6. The stackable mote device of claim 1 wherein said power-gated sensor headers are physically polarized.

7. The stackable mote device of claim 1 further comprising a switchable power regulator.

8. A configurable remote sensing device comprising:
an enclosure comprising:
powered components comprising:
a controlling circuit board comprising at least one microcontroller unit;
at least one peripheral circuit board comprising a sensor;
a storage circuit board configured to store information; and
a communication circuit board comprising a radio transmitter;
a power source; and
a voltage disconnect capable of disconnecting said power source from said powered components upon a voltage dropping below a preset threshold;
wherein said powered components are electrically coupled by physically polarized power-gated headers configured to transfer data signals and power signals through said peripheral circuit board, said storage circuit board, and said communication circuit board and wherein said powered components are configured to be electrically coupled by stacking said controlling circuit board, said at least one peripheral circuit board, said interface circuit board, said storage circuit board, and said communication circuit board in any order.

9. The configurable remote sensing device of claim 8 further comprising a display.

10. The configurable remote sensing device of claim 9 wherein said display is a colosteric liquid crystal display.

11. The configurable remote sensing device of claim 10 wherein said device is capable of printing data on said colosteric liquid crystal display at a condition selected from: a first low voltage in advance of said voltage disconnect disconnecting said power source from said powered components at said preset threshold and an integrity sensor sensing a breach of said enclosure.

12. The configurable remote sensing device of claim 8 wherein said storage circuit board comprises a flash memory card reader.

13. The configurable remote sensing device of claim 8 further comprising a GPS.

14. The configurable remote sensing device of claim 8 further comprising an integrity sensor.

15. A remote sensing device, comprising:
a plurality of peripheral circuit boards, wherein each of said plurality of peripheral circuit boards comprises a sensor;
a communication circuit board comprising an antenna and a transmitter;
a storage circuit board configured to store information;
an interface circuit board comprising an interface;
a controlling circuit board comprising a processor, wherein said controlling circuit board is configured to be electrically coupled by an electrical interconnect configured to transfer data signals and power signals through power-gated sensor headers to said communication circuit board, the storage circuit board, said interface circuit board, and said plurality of peripheral circuit boards by stacking said communication circuit board, said storage circuit board, said interface circuit board, and said plurality of peripheral circuit boards upon said controlling circuit board by a wide electrical interconnect in any order; and
a power source electrically configured to provide power through said electrical interconnect to said controlling circuit board, said storage circuit board, said communication circuit board, said interface circuit board and said plurality of peripheral circuit boards.

16. The remote sensing device of claim 15 wherein said communication circuit board comprises circuitry for communicating with at least one of a cellular network, Wi-Fi network, Zigbee network, Bluetooth network or WiMAX network.

17. The remote sensing device of claim 15 wherein said interface circuit board comprises power gating circuitry configured to provide improved energy conservation during idle periods, and wherein said power gating circuitry comprises power gated sensor headers and opto-isolated power gates.

18. The remote sensing device of claim 15 wherein said power source comprises a solar energy board stackable upon at least one of the controlling circuit board, said storage circuit board, said communication circuit board, said interface circuit board and said plurality of peripheral circuit boards.
